(19) United States
(12) Patent Application Publication
(10) Pub. No.: US 2008/0307228 A1
(43) Pub. Date: Dec. 11, 2008

(54) WEDI: AN ENCRYPTION-BASED METHOD AND SYSTEM FOR THE IDENTIFICATION AND PROTECTION OF PRINTED DOCUMENTS OR THOSE BEING TRANSMITTED BY ELECTRONIC MEANS

(76) Inventor: Eder Luiz Menezes de Faria, Brasilia (BR)

Correspondence Address: Eder Luiz Menezes de Faria, Rua Manaca Lote 2 Bloco 2 Salas 10,12 e 14, Brasilia, 71936500, BR

(21) Appl. No.: 11/761,034

(22) Filed: Jun. 11, 2007

(51) Int. Cl. H04L 9/32; G06F 12/14; G06F 17/30; G06F 9/44; H04L 9/28

(52) U.S. Cl. 713/176; 380/44; 707/3; 713/189; 719/318; 707/E17.014

(57) ABSTRACT

WEDI it is both a method and a system that uses symmetric and asymmetric encryption algorithms which makes feasible the identification of printed documents or those being transmitted by electronic means, and allows to hold responsible any person who discloses the information they contain in an illegal way or without authorization. WEDI is the acronym for “Watermark Encryption Document Identification”. It is both a method and a system that makes feasible the identification of printed documents and the information they carry upon being distributed by electronic means through the generation and printing of a cryptographic key in a watermark format, which is generated by the use of symmetric and asymmetric encryption algorithms and Hashing's function based on various data related to documents, devices, and persons involved in the process. This makes possible the identification of the aforesaid documents concerning their origin, recipient, date and time of generation and dispatch, user's responsibility, and other information pertaining such documents through the analysis of just a portion of them that contains fragments of the cryptographic key in the form of a printed watermark, which is the ultimate goal of the invention now being presented.

WEDI is the acronym for “Watermark Encryption Document Identification”. It is both a method and a system that makes feasible the identification of printed documents and the information they carry upon being distributed by electronic means through the generation and printing of a cryptographic key which is generated by the use of symmetric and asymmetric encryption algorithms and Hashing's function from data about documents, devices, and persons involved in the process. This makes possible the identification of the aforesaid documents regarding their origin, recipient, date and time of generation and dispatch, user's responsibility, and other information related to them by analyzing just a portion of these documents that contains fragments of the cryptographic key in the form of a printed watermark, which is the ultimate goal of the invention now being presented.

Specifically, the system makes use of some techniques in order to generate and print cryptographic keys based on varied pieces of information about the document, persons that produced it, devices where the request for generating it took place or the devices that generated it in the form of a watermark. The latter allows the identification of any printed document or the one being conveyed through an electronic means upon using just a section of the cryptographic key printed somewhere on the document, which makes possible to held judicially responsible the issuer, the producer, and the recipient concerning one or more electronic document in case of fortuitous disclosure, illegal or/and unauthorized use.

Historically, when an unauthorized disclosure of any private or confidential information happens through printed content or electronic media, it is very difficult to identify and/or hold someone responsible for such action due to the fact that a great number of copies of the document are passed on to several people with no handling control at all. Even if codified headings containing the identification of the recipient of the copy are attributed to these documents, such data are not stored in a structured way nor are they associated with the information pertaining to the persons who handle these documents. Thus this traditional identification method is unable to correctly identify a document by simply analyzing its fragments. When these documents are distributed in a printed format or through an electronic means by using standard procedures alone, the data related to the issuer, recipient, producer, date and time of generation, among other information regarding the documents, are not scattered over them, which makes their identification possible only by the use of their headings data.

For instance, nowadays when a private or confidential information related to proofs, evidences or any document linked to a lawsuit or a parliamentary investigation commission is made public in a printed format or electronically by a magazine or newspaper that stands large circulation, it is almost impossible to hold someone judicially responsible for its generation, distribution, and reception, and sometimes, even the identification of the document and its origin are rather difficult because just one document can generate several copies that can be inserted in different lawsuits and dossiers by a great number of non-related handlers.

The traditional process of production, copying, and electronic distribution of printed contents or its conveyance through electronic means makes the identification and control of these documents a very difficult task. However, the use of the WEDI method and system would make this procedure easier and much more reliable as it allows the correct identification of the whole process through the association of each document or part of it with the corresponding producer, sender, and recipient making it possible to hold judicially responsible all persons involved in the process regardless the number of documents and copies produced and distributed.

The goal intended to be attained by the present invention is to restrain illegal or unauthorized transmission, disclosure, and publication of private and confidential information contained in printed documents or in those divulged through electronic means in order to make feasible the identification of any person connected with them. The effective protection of private documents and information is an essential current need for both national and international organizations, industries, economic sectors, as well as for the Executive, Legislative and Judiciary.

Recent advances in encryption technology, data and computing processing, generation and transmission of printed document by electronic means, the ubiquity of the computing graphical interfaces devices, and the speed up in database information retrieval are factors enabling the present invention.

The method and system of the present invention are detailed as follows:

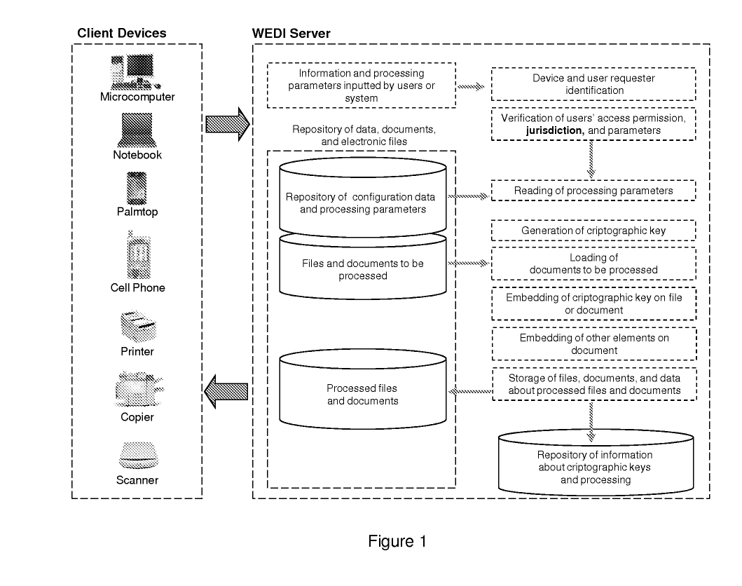

FIG. 1 illustrates the WEDI system, which is made up of two subsystems: client and server.

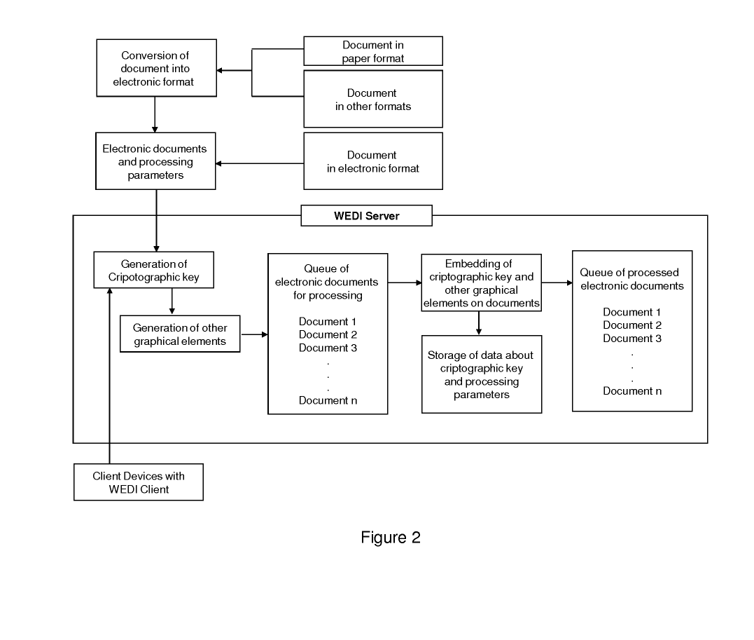

FIG. 2 is a flow diagram illustrating the processing and generation of cryptographic keys, printing of these keys generated by the document printing or through its transmission/reception by electronic means in the form of a watermark, and the storage of these keys along with the information about the data processing, the document and persons, and the devices involved in the process.

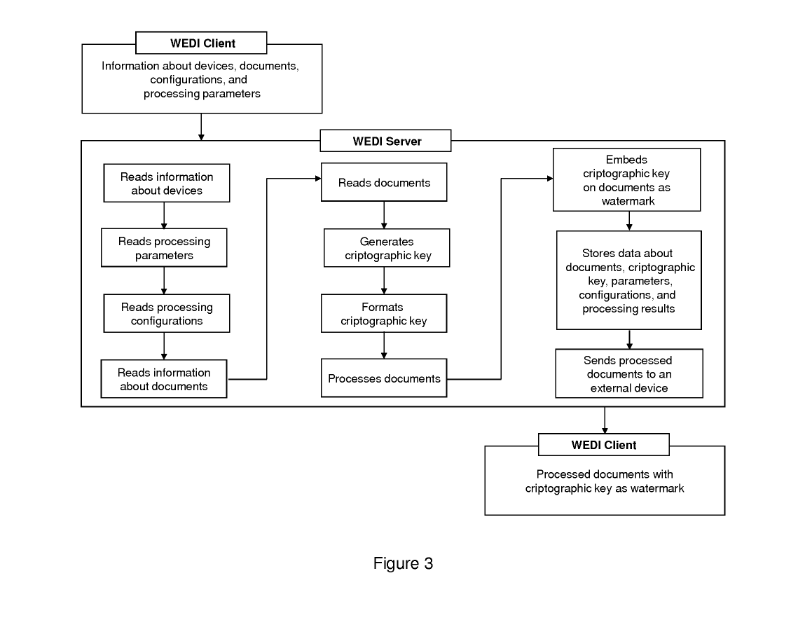

FIG. 3 is a flow diagram illustrating the key generation process and the document watermarking.

A breakdown of this flow is as follows:

(1) Identification of the client device and user requester. Initially, the data on users, client devices, and the processing parameters originated from the client device are received by the server. These data and parameters can be presented in various formats.
(2) Verification of access permissions, jurisdiction, and user's parameters. The server checks if the user access to the system has been granted in advance. If so, the configurations are loaded and options made available in accordance with user's access permissions.
(3) Processing parameters reading.
(4) Cryptographic keys generation. Based on processing parameters, user's configurations, device information, and electronic documents made available, the server produces cryptographic keys and print them, as watermarks, on electronic documents, on the client device or in any other device established by the user in the configuration system parameters. The generation of the cryptographic key is carried out by using symmetric or asymmetric algorithms and their configuration that consists of type, size, font color, printing position, columns quality, inclination angle, way characters are spread, and other configurations, which are provided by users in the processing parameters or in the configuration solution.
(5) Loading of documents to be processed.
(6) Printing of cryptographic keys on documents.
(7) Printing of other graphical elements on documents.
(8) Storage of processed documents and data concerning persons and devices involved in the process.

What is claimed is:

1. Method and system that makes feasible the identification of printed documents and the information they carry upon being distributed by electronic means through the generation and printing of a cryptographic key which is generated by the use of symmetric and asymmetric encryption algorithms and Hashing's function originated from data about the documents, devices, and persons involved in the process. This makes possible the identification of the aforesaid documents concerning their origin, recipient, date and time of generation and dispatch, user's responsibility, and other information related to them through the analysis of just a portion of these documents that contains fragments of the cryptographic key in the form of a printed watermark.

2. The system of claim 1 comprises the client and server subsystems.
The server subsystem is composed of the following modules:
a) cryptographic keys-generation module, responsible for the generation of cryptographic keys based on data and predefined configurations by deploying cryptography techniques and symmetric and asymmetric algorithms alongside Hashing's function;
b) cryptographic keys-embedding module, responsible for storing in hardware, software, and other electronic means the keys generated from structured or not structured databanks;
c) documents-printing module, responsible for the generation of printed or electronic documents with the printing of the watermark along with the cryptographic keys and other graphical elements, in accordance with predefined configurations;
d) documents repository, responsible for storing electronic documents to be processed, and those already processed by the system;
e) data repository, responsible for storing data concerning generated electronic documents, including data on the generated cryptographic key, documents access password, configuration used, devices involved, and other processing data;
f) system-configuration module, responsible for the configuration of the system from data and information inputted in the user device interface (cell phone, personal computer, personal digital assistant etc);
g) monitoring and event notification module;
h) user authentication module, responsible for the authentication of a system user from data and information inputted in the user device interface (cell phone, personal computer, personal digital assistant etc);
i) security module for information and electronic documents confidentiality assurance by the use of cryptographic techniques;
j) configuration repository, responsible for storing data and information about the configuration system and personalized configuration taking into account the organization, the organizational unit, and the corresponding user;
k) search module, responsible for conducting searches in the keys and electronic documents repository based on established search parameters, and also responsible for results exhibition.
The client subsystem is composed of the following modules:
a) user data-capture module, responsible for gathering user authentication information inputted in the user device interface (cell phone, personal computer, personal digital assistant, portable computer etc);
b) module for capturing the system configuration inputted in the user device interface (cell phone, personal computer, personal digital assistant, portable computer etc) responsible for gathering information and system configuration data;
c) processing follow-up module, responsible for the exhibition of the information being processed;
d) processing configuration module, responsible for the definition of documents and parameters to be used in the processing;
e) monitoring and event notification module;
f) search module, responsible for defining search parameters to be used in electronic documents and cryptographic keys searches.

3. The communication method of claims 1 and 2, characterized by the transmission of one or more electronic documents in varied formats such as PostScript, TIFF, GIF, JPG, DOC, PNG, RTF, PDF, among others, from a costumer device (cell phone, personal computer, personal digital assistant, portable computer etc) to the server subsystem that initially identifies the user and his security data, comprising the following steps:
a) If the user data are validated by the server subsystem or client subsystem, the user access to the system will be granted. Afterwards, the system authenticates the user, and an interface requesting the processing parameters will be exhibited;
b) If the user data are not validated, the system will request the user to inform the security access data again for as many times as predefined by the configuration system. In case the number of authorized entries is exceeded, the user access will be blocked by the system.
c) if the documents are sent from a client device, the system will store temporarily or definitively the documents for processing and then the documents will be printed or electronically generated along with the cryptographic keys in watermark format, in accordance with the configuration system;
d) if the documents are obtained through a temporary or definitive preexisting repository, the system will read the repository of origin concerning the documents to be processed and afterwards they will be printed or electronically generated along with the cryptographic keys in watermark format, in accordance with the configuration system;

4. The Cryptographic keys generation method of claim 1, 2, and 3, characterized by the application of symmetric or asymmetric cryptographic algorithms or Hashing's function over data and information related to electronic documents, devices, and persons involved in the process, in accordance with the configuration and processing parameters established by the user.

5. The generation of printed or electronic documents method of claim 1, 2, 3, and 4, characterized by the generation of documents in varied formats such as PostScript, TIFF, GIF, JPG, JPEG, PNG, RTF, PDF, DOC with the generated cryptographic key as a watermark, and other information in accordance with the configuration used and the established processing parameters.
